(19) United States
(12) Patent Application Publication
(10) Pub. No.: US 2015/0168346 A1
(43) Pub. Date: Jun. 18, 2015

(54) ACQUIRING PROVISIONING DATA FOR AN ELECTROLYSIS SYSTEM

(71) Applicants: Erik Wolf, Rottenbach (DE); Andreas Wiest, Muhlhausen (DE); Klaus Scheffer, Nurnberg (DE); Fred Farchmin, Wendelstein (DE)

(72) Inventors: Erik Wolf, Rottenbach (DE); Andreas Wiest, Muhlhausen (DE); Klaus Scheffer, Nurnberg (DE); Fred Farchmin, Wendelstein (DE)

(21) Appl. No.: 14/132,335

(22) Filed: Dec. 18, 2013

(51) Int. Cl. G01N 27/416

(52) U.S. Cl. CPC G01N 27/4163

(57) ABSTRACT

A method for acquiring provisioning data for an electrolysis system is disclosed. Selection information is transmitted over a network to a user. Provisioning data is received over the network based on input by the user. The provisioning data includes a value indicating a power to be supplied to the electrolysis system.

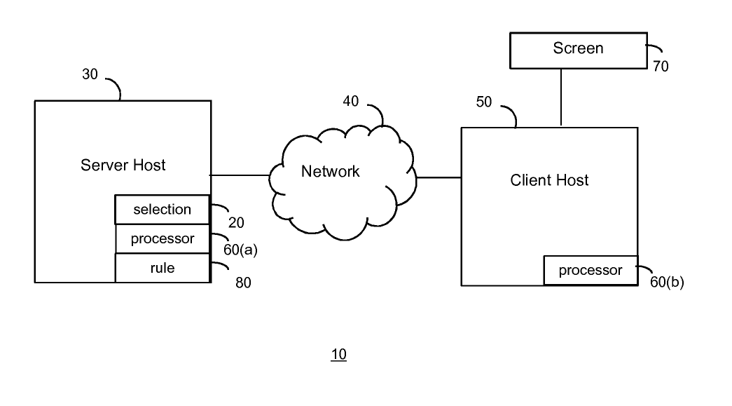

### FIELD OF INVENTION

The present disclosure relates to acquiring provisioning data for an electrolysis system.

### BACKGROUND OF INVENTION

Sustainable electrical generation, also known a renewable energy, is becoming more important especially in light of diminishing resources across the globe. Electrolysis systems use electricity to split water into hydrogen and oxygen so that the hydrogen may be used as a fuel. Alkaline electrolysis and proton exchange membrane (PEM) electrolysis are types of electrolysis based on different technologies. Regardless of the technology, there are many considerations in provisioning an electrolysis system which makes it difficult if not impossible to have a generically provisioned electrolysis system.

### SUMMARY OF INVENTION

A goal, according to the present disclosure, is to overcome these difficulties and allow for a flexible acquisition of provisioning data. Such a flexible acquisition provides for a customized electrolysis system that addresses such issues as economic efficiency, safety considerations and environmental pollution considerations. As would be appreciated by those skilled in the art, the issues may have conflicting results. For example, increasing the efficiency might be desirable but the result may be undesirable in environmental pollution considerations.

A method for acquiring provisioning data for an electrolysis system is provided. The method includes transmitting selection information over a network to a user and receiving provisioning data over the network based on input by the user, the provisioning data includes a value indicating a power to be supplied to the electrolysis system. A basic system may be provisioned based on the value indicating the power to be supplied to the electrolysis system. The basic system would include the infrastructure (hardware and any necessary software) to operate the basic system. For example, high-pressure circuit, low-pressure circuit, control system, stack with water and gas management, sensory system and safety circuits, may be provisioned

In an embodiment, the selection information includes a plurality of features which are displayed to a user. The display may be on any suitable screen for displaying images, for example, a monitor, a notebook screen, an IPOD screen, or a cellular device. The features define how the electrolysis system is to be provisioned. The plurality of features includes a base provisioning feature which is the minimum requirement for provisioning the electrolysis system. The base provisioning data describes a power supplied to the electrolysis system. For example, the base provisioning data may be a value in megawatts (MW) that would be supplied to the electrolysis system. The provisioning data would be used to determine how many skids would be required to according to the power supplied. Each skid may include the infrastructure previous described.

Features may be categorized as feature types: functional feature, usage feature, regulatory feature, and service feature. By having different feature types it is possible to provide different displays to the user using different feature types. The feature types, with the exception of the service feature, are merely a way to categorize the same group of features in different meaningful ways. Furthermore, a feature may be divided into subfeatures as will be explained in more detail below.

Functional feature: Functional features are described in terms of the functionality of the feature and may include:
a cooling system—cools the electrolysis system to avoid overheating;
water treatment—treats the water separated during the electrolysis process;
power—power supplied to the electrolysis system;
grid connection—connection for supplying fuel to the power grid;
dryer removes oxygen and water from hydrogen to obtain a higher quality of hydrogen
safety technology—provide safety;
gas monitoring system—monitors the quality of the hydrogen;
fire detection—detects a fire condition;
lightning protection—protects against lightning;
data interface connection—type of protocol used in a data interface connection
overload operation—handles overload situation.

It would be understood that the above list is not an exhaustive list of features that could be used. Furthermore, the features may be flexibly provided. Features may have multiple feature selections when different provisioning choices are available for the feature. In contrast to multiple features, a feature may be divided into subfeatures. By way of example, we assume that the data interface connection may be provisioned in the form of a VHP data interface connection or a CRSP interface connection. When multiple features selections are used, VHP data interface connection and CRSP interface connection would be displayed as the features. However, when subfeatures are used the data interface connection would be the feature and VHP data interface connection and CRSP interface connection would be provided as subfeatures. This provides extra flexibility in displaying features in a meaningful way to the user.

Usage feature: Electrolysis systems have different usages such as filling station or fuel for the power grid. The usage feature describes how the electrolysis system is used, Based on this usage some functional features may be desirable or required for the usage and others may be unnecessary or undesirable. By way of example we assume a hydrogen filing station requires a high quality of the hydrogen such as 99.99% hydrogen and requires extensive safety measures. In order to achieve the quality of hydrogen a dryer may be required and for the safety a fire-alarm system, lightning protection and overload operation may be required. It can be seen that the usage feature relates to the functional features but that the functional features may be automatically provided or dynamically displayed differently based on the use of the electrolysis system. This provides an intelligent assistance to the user.

Regulatory feature: Electrolysis systems may have regulations which regulate operation. For example, safety and/or environmental aspects may be regulated. These regulations requirements may differ based on the site of the installation. For example, the country, state, or region of the site may have different regulations. The regulations may also differ based on an installation date. Furthermore, regulations may be different based on site conditions such as the type of plant or animal species in the area. Additionally the regulation may be different based on the usage. Similarly to the usage feature, the regulatory feature may group functional features. However instead of grouping the functional features by usage the functional features are grouped based on regulation considerations such as installation site, installation date, site considerations and the use of the electrolysis system.

Service feature: Service features provide for spare hardware parts and levels of technical support. Technical support may include on-call service, routine maintenance service, and achievability support.

In order to simplify the description, hereinafter the use of term feature includes the term subfeatures.

In an embodiment, the plurality of features includes a feature from at least one feature type. The feature types are functional feature, usage feature, regulatory feature, installation feature, and service feature.

The plurality of features may be displayed via a user interface such as a graphical user interface (GUI) format with components allowing user input. The components may be dropdowns, radio buttons, windows, menus, check boxes, icons and the like. In an embodiment, the features are statically displayed where the features are not added or removed based on a selection of a different feature. However, in another embodiment the features are dynamically displayed and the features change based on criteria such as a selection of features or the sophistication of the user. For example, if a particular usage is selected then other features may be removed and/or added. Additionally features may be mutually exclusive so if one a set of mutually exclusive features is selected the others may be dynamically removed. The display may also be changed based on a sophistication or need of the user. For example, for one user the display may only have functional features while for another user the display may have regulatory features.

The display may be created or dynamically changed using rule based data. For example, each of the features may be associated with one or more rule. The rule based data may be stored on the network in a location the user does not have access. However, it is possible the rule based data be transmitted to the user.

In an embodiment, the electrolyser system is provisioned based on the input from the user. The provisioning includes the infrastructure required based acquired provisioning data. In some cases the provisioning is based on a size requirement. For example, the number skids may increase linearly based on the wattage supplied to the electrolyser system. If each module unit required 1.25 megawatts then 4 skids would be provisioned for a 5 MW system. Likewise, the cooling system might be provisioned by size so that each skid would have a respective cooling system. In other cases, the provisioning is binary, that is, hardware, software or support is provided or not provided. For example, a monitoring system is either provided or not provided and is not based on a size.

It would be understood that elements and/or characteristics of different embodiments may be combined in any combination.

### BRIEF DESCRIPTION OF THE DRAWINGS

The disclosure is further described hereinafter with reference to illustrated embodiments shown in the accompanying drawing illustrating a client server model for providing the method for acquiring provisioning data for an electrolysis system.

### DETAILED DESCRIPTION OF THE DRAWINGS

A method for acquiring provisioning data for an electrolysis system may be facilitated by an application such as a web based application or a standalone application. Distributed functionality may be used by the application. While the following embodiment is described in terms of a client-server model 10 it would be understood that other models could easily be used.

Selection information 20 transmitted from a server host 30 over network 40 to a client host 50. It is noted that server host 30 and the client host 50 each have processors 60(a) and 60(b) respectively. The selection information 20 is displayed on a screen 70 which is part of or connected to the client-host 50.

The selection information provides features to be selected by a user of the client host 50. Rule based data 80 may be provided in order to determine which features will be displayed. In the present embodiment, the rule based data 80 is stored on the server host 30. However, one skilled in the art would recognize that it may easily be stored anywhere accessible by the network.

In addition to providing what features will be displayed, the rule based data 80 may also provide the formatting of the display.

Error checking of input entered by the user may be performed at the client host 50 and or the server host 30.

After a user has entered input, provisioning data is sent to the sever host 30. The provisioning data may be sent after the user has finished entering all input or at various stages of input entry.

While the present disclosure has been described in detail with reference to certain embodiments, it should be appreciated that these embodiments do not limit the present invention. Modifications and variations would present themselves, to those of skill in the art, without departing from the scope and spirit of the present invention.

We claim:

1. A method for acquiring provisioning data for an electrolysis system, comprising:
transmitting selection information over a network to a user; and
receiving provisioning data over the network based on input by the user, the provisioning data includes a value indicating a power to be supplied to the electrolysis system.

2. The method as claimed in claim 1,
wherein the selection information includes a plurality of features which are displayed to the user; and
wherein the plurality of features includes a base provisioning feature comprising a power input selection.

3. The method as claimed in claim 1,
wherein the plurality of features includes at least one feature selected from the group functional feature, usage feature, regulatory feature, installation feature and service feature.

4. The method as claimed in claim 1,
wherein the plurality of features is displayed statically.

5. The method as claimed in claim 1,
wherein the plurality of features displayed dynamically.

6. The method as claimed in claim 1,
wherein the display is based on rule based data.

7. The method as claimed in claim 1,
wherein the rule based data is not transmitted to the user.

8. The method as claimed in claim 1, comprising:
provisioning the electrolysis system with an infrastructure according to the acquired provisioning data.

9. The method as claimed in claim 1, comprising:
providing a technical support according to the acquired provisioning data.

10. The method as claimed in claim 1,
wherein the provisioning data comprises a feature item which indicates a provisioning based on a functional feature, a usage feature, a regulatory feature, an installation feature or a service feature.

11. The method as claimed in claim 10,
wherein the feature item indicates a regulatory feature and the functional features are determined from the regulatory feature.

12. The method as claimed in claim 10,
wherein the feature item includes a usage data which indicates a type of the electrolysis system and the functional features are determined from the type.
